(19) United States
(12) Patent Application Publication
(10) Pub. No.: US 2026/0364882 A1
(43) Pub. Date: Nov. 19, 2026

(54) MULTI-NOZZLE THREE-DIMENSIONAL PRINTING SYSTEM

(71) Applicant: International Business Machines Corporation, Armonk, NY (US)

(72) Inventors: Michael BOONE, Lutz, FL (US); Martin G. KEEN, Cary, NC (US); Sarbajit Kumar RAKSHIT, Kolkata (IN); Carolina GARCIA DELGADO, Zapopan (MX)

(21) Appl. No.: 19/208,725

(22) Filed: May 15, 2025

(51) Int. Cl. B29C 64/336; B22F 10/14; B22F 10/30; B22F 10/85; B28B 1/00; B28B 17/00; B29C 64/112; B29C 64/165; B29C 64/209; B29C 64/393; B33Y 10/00; B33Y 30/00; B33Y 50/02

(52) U.S. Cl. CPC B29C 64/336; B22F 10/14; B22F 10/30; B22F 10/85; B28B 1/001; B28B 17/0081; B29C 64/112; B29C 64/165; B29C 64/209; B29C 64/393; B33Y 10/00; B33Y 50/02; B33Y 30/00

(57) ABSTRACT

In some implementations, a printing system may receive information associated with printing a three-dimensional (3D) object. The printing system may determine a thickness of a layer of granular particles associated with a first layer of the 3D object, wherein the thickness of the layer of the granular particles is determined based on the information associated with the 3D object, a property of the granular particles, and a property of a liquid binder material. The printing system may deposit, via a first nozzle, the granular particles to form the layer of the granular particles in accordance with the thickness. The printing system may apply, using a second nozzle that is different from the first nozzle, the liquid binder material to the layer of granular particles to form a layer of the 3D object.

### BACKGROUND

This disclosure relates to three-dimensional printing, and more specifically, to a multi-nozzle three-dimensional printing system.

### SUMMARY

Some aspects described herein relate to a method. The method may include receiving, by a printing system, information associated with printing a three-dimensional (3D) object. The method may include determining a thickness of a layer of granular particles associated with a first layer of the 3D object. The thickness of the layer of the granular particles may be determined based on the information associated with the 3D object, a property of the granular particles, and a property of a liquid binder material. The method may include depositing, via a first nozzle, the granular particles to form the layer of the granular particles in accordance with the thickness. The method may include applying, using a second nozzle that is different from the first nozzle, the liquid binder material to the layer of granular particles to form a layer of the 3D object.

Some aspects described herein relate to a printing system. The printing system may include a processor set, one or more computer-readable storage media, and program instructions stored on the one or more computer-readable storage media to cause the processor set to perform operations. The operations may include receive information associated with printing a 3D object. The operations may include determining a thickness of a layer of granular particles associated with a first layer of the 3D object. The thickness of the layer of the granular particles may be determined based on the information associated with the 3D object, a property of the granular particles, and a property of a liquid binder material. The operations may include depositing, via a first nozzle, the granular particles to form the layer of the granular particles in accordance with the thickness. The operations may include applying, using a second nozzle that is different from the first nozzle, the liquid binder material to the layer of granular particles to form a layer of the 3D object.

Some aspects described herein relate to a non-transitory computer-readable medium that stores a set of instructions. The set of instructions, when executed by one or more processors of a printing system, may cause the printing system to receive information associated with printing a 3D object. The set of instructions, when executed by one or more processors of the printing system, may cause the printing system to determine a thickness of a layer of granular particles associated with a first layer of the 3D object. The thickness of the layer of the granular particles may be determined based on the information associated with the 3D object, a property of the granular particles, and a property of a liquid binder material. The set of instructions, when executed by one or more processors of the printing system, may cause the printing system to deposit, via a first nozzle, the granular particles to form the layer of the granular particles in accordance with the thickness. The set of instructions, when executed by one or more processors of the printing system, may cause the printing system to apply, using a second nozzle that is different from the first nozzle, the liquid binder material to the layer of granular particles to form a layer of the 3D object.

### BRIEF DESCRIPTION OF THE DRAWINGS

FIG. 1 is a diagram of an example computing environment for a multi-nozzle three-dimensional (3D) printing system described herein.

FIGS. 2A-2I are diagrams of an example implementation associated with a multi-nozzle 3D printing system.

FIG. 3 is a diagram of example components of a device associated with a multi-nozzle 3D printing system.

FIG. 4 is a flowchart of an example process associated with a multi-nozzle 3D printing system.

### DETAILED DESCRIPTION

The following detailed description of example implementations refers to the accompanying drawings. The same reference numbers in different drawings may identify the same or similar elements.

In some cases, three-dimensional (3D) printing may be utilized in the construction of large objects. To construct these large objects, a 3D printing system may utilize high viscosity materials and/or sticky, semi-solid filler materials. However, it may be difficult to effectively deposit these highly viscous or sticky semi-solid filler materials, which can lead to subpar products or require additional processing steps. For example, the high viscosity of these materials can cause clogging, uneven deposition, or other issues that compromise the structural integrity of the final product. Furthermore, existing 3D printing methods may not adequately address the need for customized material properties, such as varying levels of strength, texture, or flexibility, within a single object.

Some implementations described herein provide a 3D printing system that utilizes multiple nozzles to create large-scale objects, objects with complex structures, and/or objects having customized material properties. In some implementations, the 3D printing system may receive information associated with printing a 3D object and may determine a thickness of a layer of granular particles based on the object's design (e.g., indicated by the information associated with printing the 3D object), the properties of the granular particles, and the properties of a liquid binder material. In some implementations, the 3D printing system may dispense the granular particles via a first nozzle to form the layer of granular particles according to the determined thickness, and may apply the liquid binder material via a second, different nozzle to solidify the layer of granular particles.

In some implementations, the 3D printing system may analyze properties of various types of granular particles and liquid binder materials to identify features that influence layer thicknesses. In some implementations, the 3D printing system may train a machine learning model to learn relationships between these features and the layer thicknesses and may use the trained model to generate an output indicating the thickness of the layer, the type of granular particles, and the type of liquid binder material.

In this way, the 3D printing system may optimize deposition rates and layer thicknesses to minimize material waste and reduce the computational complexity of 3D printing tasks.

Additionally, the use of multiple, different nozzles may allow for an increase in the efficiency of depositing granular particles and/or applying liquid binder material. For example, the 3D printing system may select a nozzle for depositing a particular granular particle based on the properties of the nozzle (e.g., a size of an opening of the nozzle, a rate at which the nozzle is able to deposit granular particles, and/or the like) and/or a property of the granular particle (e.g., a size or composition of the granular particle). Similarly, the 3D printing system may select a nozzle for applying a liquid binder material based on the properties of the nozzle (e.g., a spray pattern and a flow rate). The 3D printing system may also conserve computing resources, networking resources, and other resources that would have otherwise been consumed by failing to efficiently deposit highly viscous or sticky materials, slowing performance of tasks due to inefficient material deposition, creating an unsafe environment due to inefficient material deposition, damaging property due to inefficient material deposition, and/or the like. Further, use of the machine learning model to determine the thickness of a layer, the type of granular particles, and the type of liquid binder material may improve algorithmic efficiency in processing complex 3D printing data.

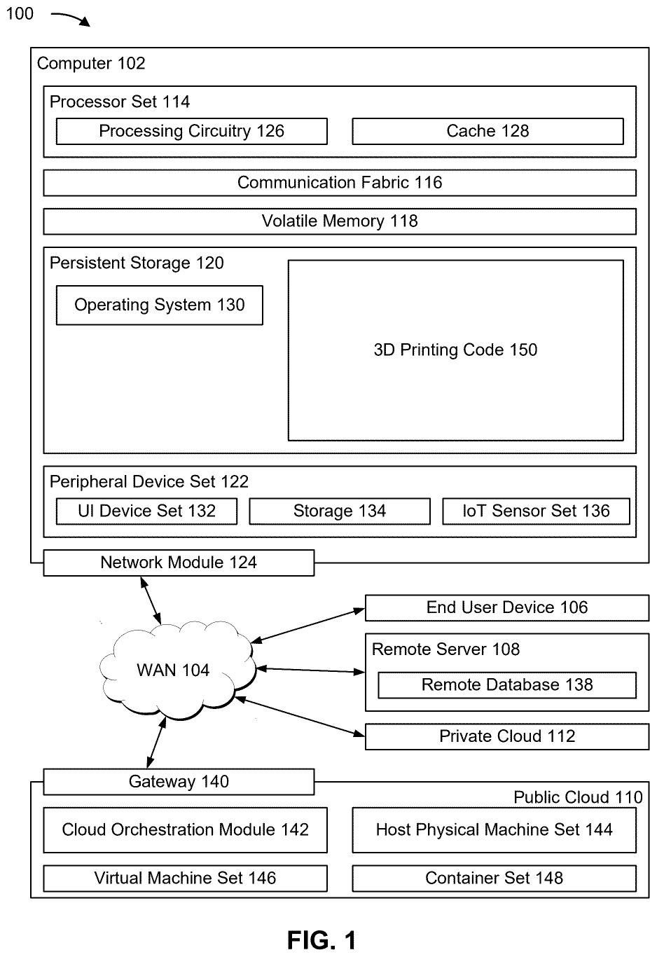

FIG. 1 is a diagram of an example computing environment 100 for multi-nozzle 3D printing system described herein.

The computing environment 100 contains an example of an environment for the execution of at least some of the computer code involved in performing the inventive methods, such as printing code 150. In addition to the printing code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the printing code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

The processor set 114 includes one, or more, computer processors of any type now known or to be developed in the future. The processing circuitry 126 may be distributed over multiple packages, for example, multiple, coordinated integrated circuit chips. The processing circuitry 126 may implement multiple processor threads and/or multiple processor cores. The cache 128 is memory that is located in the processor chip package(s) and is typically used for data or code that should be available for rapid access by the threads or cores running on the processor set 114. Cache memories are typically organized into multiple levels depending upon relative proximity to the processing circuitry. Alternatively, some, or all, of the cache for the processor set may be located “off chip.” In some computing environments, the processor set 114 may be designed for working with qubits and performing quantum computing. Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in printing code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples.

Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to the computer 102 and/or directly to the persistent storage 120. The persistent storage 120 may be a read only memory (ROM), but typically at least a portion of the persistent storage allows writing of data, deletion of data and re-writing of data. Some familiar forms of persistent storage include magnetic disks and solid state storage devices. The operating system 130 may take several forms, such as various known proprietary operating systems or open source Portable Operating System Interface-type operating systems that employ a kernel. The code included in the printing code 150 typically includes at least some of the computer code involved in performing one or more operations described herein.

In some implementations, the operations may include receiving information associated with printing a 3D object and determining a thickness of a layer of granular particles associated with a first layer of the 3D object. In some implementations, the thickness of the layer of the granular particles is determined based on the information associated with the 3D object, a property of the granular particles, and a property of a liquid binder material. In some implementations, the operations may include depositing, via a first nozzle, the granular particles to form the layer of the granular particles in accordance with the thickness and applying, using a second nozzle that is different from the first nozzle, the liquid binder material to the layer of granular particles to form a layer of the 3D object.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

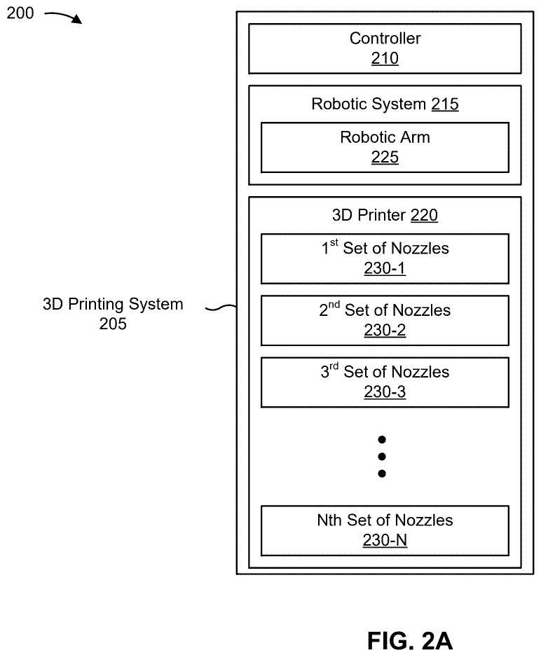

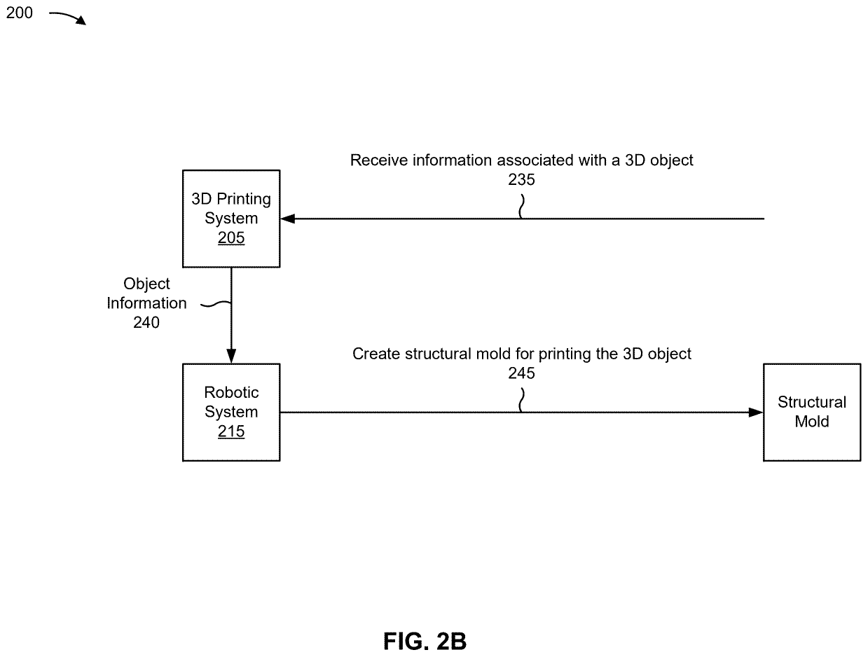

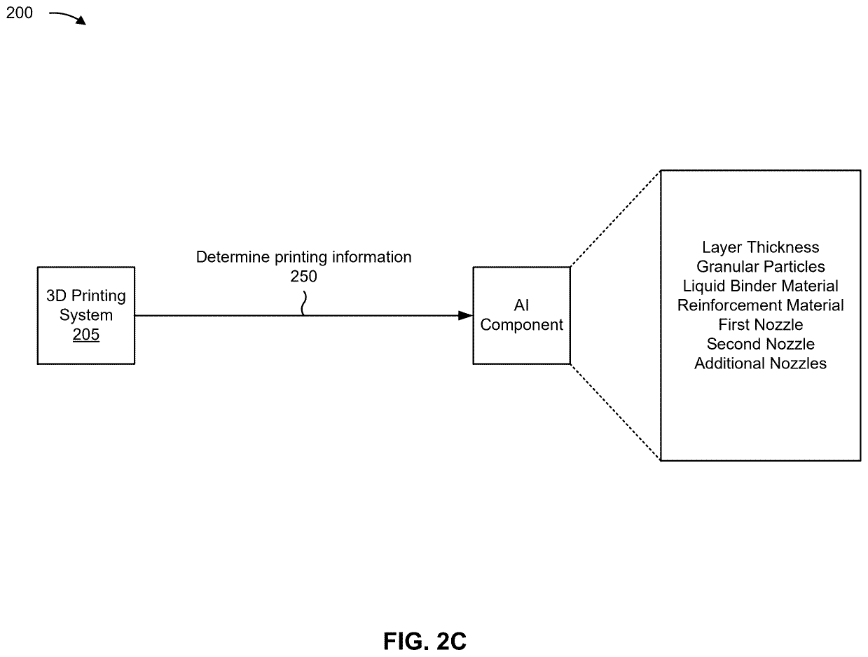

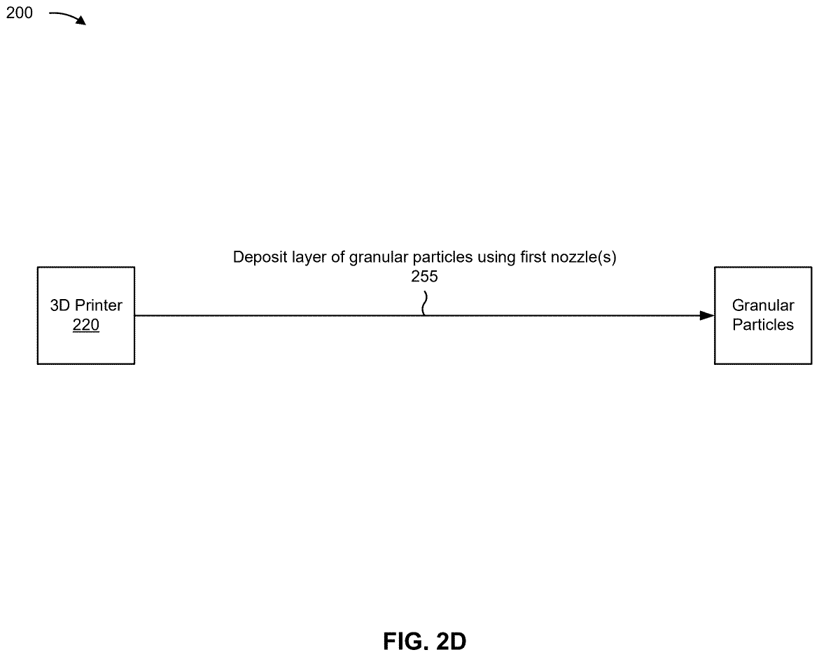

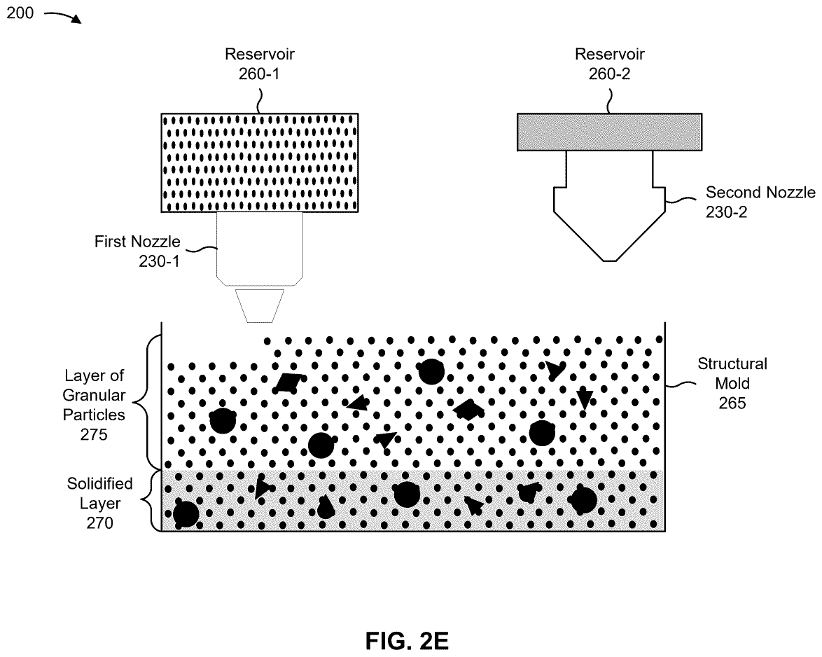

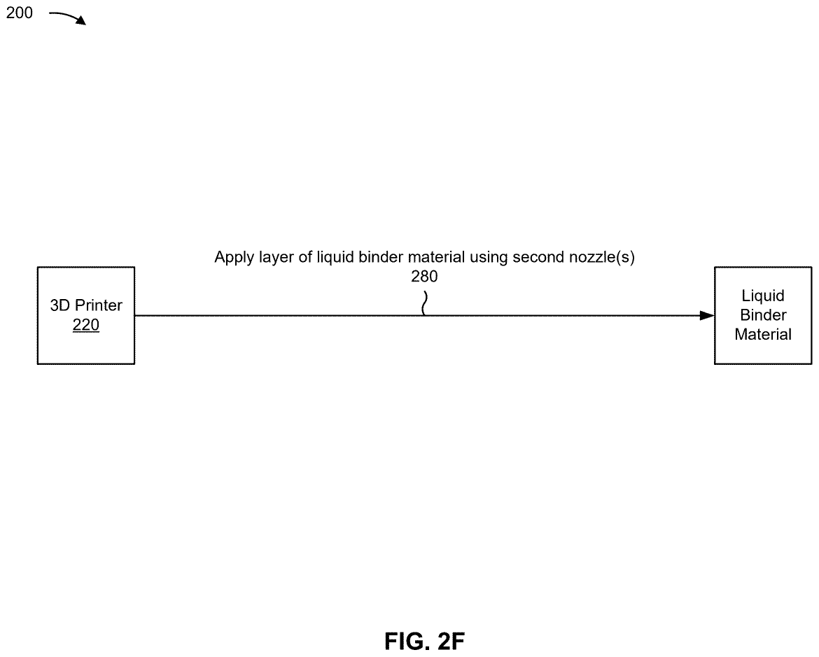

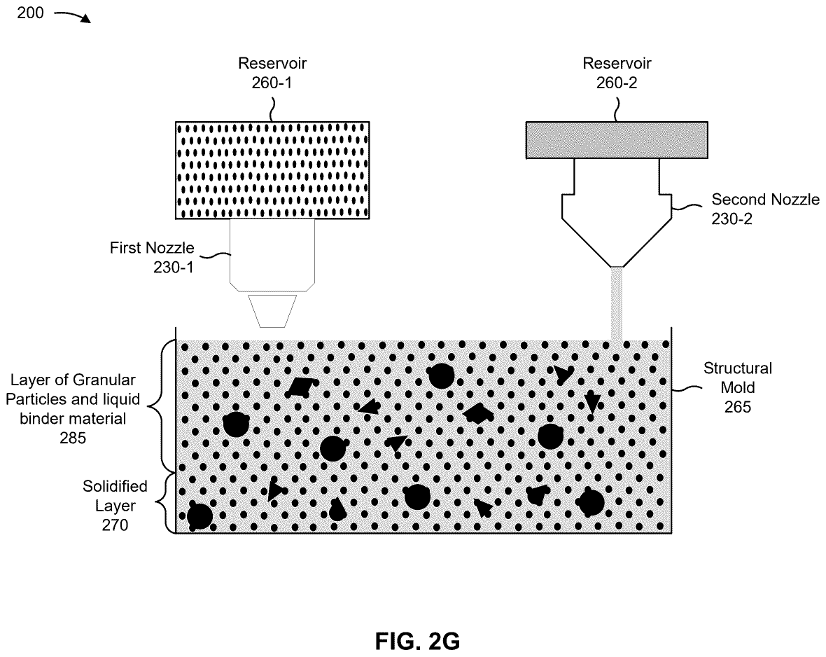

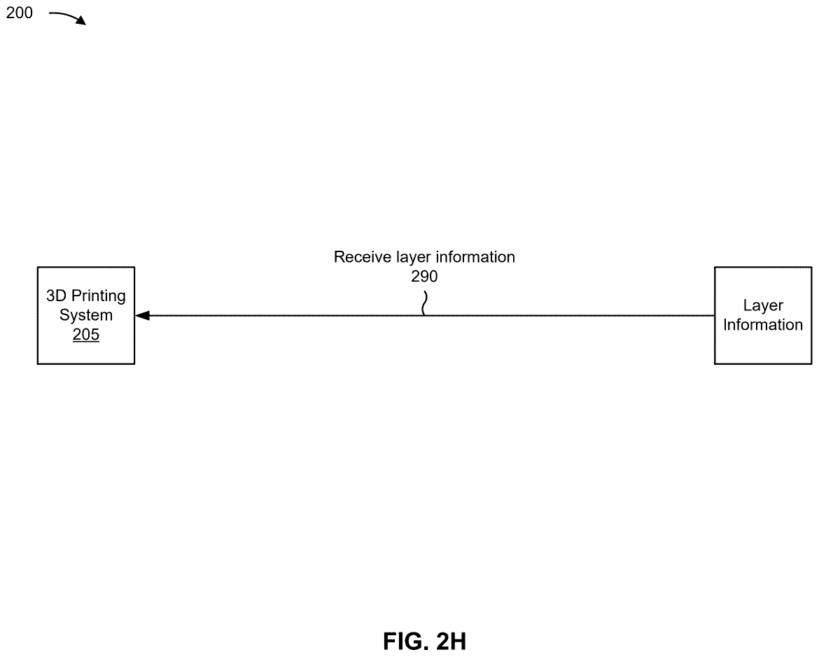

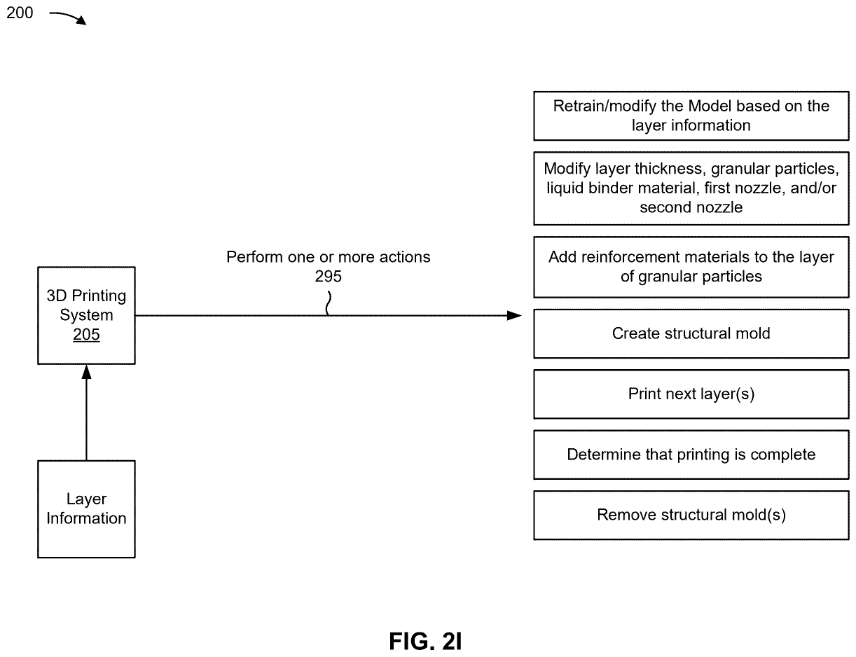

FIGS. 2A-2I are diagrams of an example implementation 200 associated with multi-nozzle 3D printing system. As shown in FIGS. 2A-2I, example implementation 200 includes a 3D printing system 205 that includes and a controller 210, a robotic system 215, a 3D printer 220, and 3D printer 220. In some implementations, the 3D printing system 205 (e.g., the controller 210) is connected to the robotic system 215 and/or the 3D printer 220, via one or more wired or wireless communication channels (not shown).

In some implementations, the controller 210 comprises one or more processors configured to determine one or more parameters associated with printing a 3D object. In some implementations, the controller 210 includes an automated intelligence (AI) component (e.g., a machine learning model or a machine learning algorithm, among other examples) that is trained to determine the one or more parameters associated with printing a 3D object. For example, the controller 210 may include an AI component that is configured to a thickness of a layer of a 3D object, a type of granular particle to be used to form the layer of a 3D object, a size of the type of granular particle, a nozzle 230 to be used to dispense the granular particles, a type of liquid binder material to be applied to a layer of the granular particles, a nozzle 230, a flow rate for applying the liquid binder material, whether a structural mold is to be created and/or utilized, or whether a reinforcement material is to be added to a layer of granular particles, among other examples.

In some implementations, the robotic system 215 comprises one or more devices configured to physically manipulate objects in response to commands received from the controller 210. In some implementations, the robotic system 215 includes a robotic arm 225 that is capable of creating and/or positioning a structural mold (e.g., structural mold 265, shown in FIGS. 2E and 2F) onto a build platform of the 3D printer 220. In some implementations, the structural mold may be configured to hold granular particles that are deposited into a cavity of the structural mold by a nozzle 230 of the 3D printer 220 during the printing process, ensuring that the granular particles maintain a shape and structure during the printing process. In some implementations, the robotic system 215 is equipped with sensors that allow the robotic system 215 to detect the position and orientation of the structural mold, ensuring that the structural mold is properly aligned a nozzle 230 of the 3D printer 220.

In some implementations, the 3D printer 220 may include one or more devices configured to print 3D objects using a variety of materials, including plastics, metals, and ceramics. In some implementations, the 3D printer 220 may include multiple nozzles 230 that can deposit different materials onto a build platform or work surface of the 3D printer 220 (not shown). In some implementations, as shown in FIG. 2A, the 3D printer 220 may include multiple sets of nozzles 230 (e.g., a first set of nozzles 230-1 through an Nth set of nozzles 230-N).

In some implementations, the multiple sets of nozzles 230 may be associated with depositing or applying different substances during a 3D printing process. In some implementations, the multiple sets of nozzles 230 may include a first set of nozzles 230-1 associated with depositing granular particles. In some implementations, the first set of nozzles 230-1 may include a plurality of nozzles 230 for depositing granular particles of different sizes or compositions at different rates of speed, or with different levels of accuracy, among other examples.

In some implementations, the multiple sets of nozzles 230 may include a second set of nozzles 230-2 associated with applying a liquid binder material to a layer of granular particles.

In some implementations, the second set of nozzles 230-2 may include a plurality of nozzles 230 for applying different types of liquid binder material, at different flow rates, or with different spray patterns, among other examples.

In some implementations, the multiple sets of nozzles 230 may include a third set of nozzles 230-3 associated with depositing or applying additional materials, granular particles, or liquid binder materials. For example, the third set of nozzles 230-1 may include one or more nozzles for depositing reinforcement materials, depositing a type of granular particle in conjunction with, or at the same time as, a first nozzle 230-1 is depositing the same or a different type of granular particle, or applying a second type of liquid binder material in conjunction with, or at the same time as, a second nozzle 230-2 is applying the same or a different type of liquid binder material.

As shown in FIG. 2B, and by reference number 235, the 3D printing system 205 may receive information associated with a 3D object. In some implementations, the information associated with the 3D object may include design specifications, structural requirements, dimensions, material requirements, and other relevant data necessary for printing the 3D object. In some implementations, the information may be provided in the form of a digital 3D model or other suitable formats that the 3D printing system can interpret and process.

In some implementations, the 3D printing system 205 may analyze the information associated with the 3D object and may generate object information. For example, the 3D printing system 205 may provide the information associated with the 3D object to the AI component and the AI component may generate an output indicating the object information.

In some implementations, the object information may include specifications for creating a structural mold that will be used to support the 3D object during the printing process. For example, the structural mold information may indicate dimensions of the structural (e.g., a height, width, length, volume, and/or the like), a location on the work surface at which the structural mold is to be placed, a type of material, or whether the structural mold is to remain stationary or is to move as the granular particles are being deposited or the liquid binder material is being applied, among other examples. In some implementations, the structural mold may be configured to maintain the shape and stability of the granular particles as they are deposited and subsequently solidified by the liquid binder material.

In some implementations, the objection information may indicate a set of parameters for printing the 3D object. For example, the object information may include information indicating a thickness of the granular particle layers, a type of granular particles to be used, properties of a liquid binder material to be applied to the granular particles, whether a reinforcement material should be utilized, or structural mold information, among other examples.

As shown by reference number 240, the 3D printing system 205 provides the object information to the robotic system 215. As shown by reference number 245, the robotic system 215 may create the structural mold for printing the 3D object. In some implementations, the robotic system 215, may utilize the robotic arm 225 to create the structural mold based on the object information. In some implementations, the robotic arm 225 and/or the robotic system 215 may be equipped with sensors and actuators that allow the robotic arm to position and construct the structural mold.

In some implementations, the robotic system 215 uses the robotic arm 225 to position the components of the structural mold on the work surface. In some implementations, the robotic system 215 may position the components of the structural mold components to enable the structural mold to receive and maintain the granular particles in accordance with the shape and dimensions of the 3D object during the printing process.

In some implementations, the robotic system 215 may utilize the robotic arm 225 to assemble the structural mold by connecting the components. For example, the robotic system 215 may utilize the robotic arm 225 to weld, fasten, or utilize other assembly techniques to assemble the components into the structural mold.

In some implementations, the robotic system 215 may be configured to align the structural mold with a nozzle 230 or a path via which a nozzle 230 is to travel. For example, the object information may indicate a position, a set of positions, or a path at which a nozzle 230 or a particle set of nozzles 230 are to dispense granular particles into the structural mold and/or to apply a liquid binder material to a layer of granular particles within the structural mold. The robotic system 215 may utilize the robotic arm 225 to align and/or orient the structural mold in accordance with the position, the set of positions, or the path.

In some implementations, the robotic system 215 may verify a placement, alignment, or orientation of the structural mold. For example, the robotic system 215 (e.g., the robotic arm 225) may include one or more sensors configured to obtain information indicating a location of the structural mold on the work surface. The 3D printing system 205 (e.g., the controller 210) may analyze the information obtained by the one or more sensors and may verify a location of the structural mold based on the information. For example, the 3D printing system 205 may determine whether the location, alignment, and/or orientation of the structural mold corresponds to (e.g., the same as) the location, alignment, and/or orientation determined by the 3D printing system 205 and included in the object information. In this way, the 3D printing system 205 may ensure that the structural mode is located, aligned, and/or oriented in a manner that enables the accurate deposition of the granular particles and application of the liquid binder material.

In some implementations, the 3D printing system 205 may determine that the structural mold is not at a location, aligned, and/or oriented in a manner that enables the accurate deposition of the granular particles and application of the liquid binder material. In these implementations, the 3D printing system 205 (e.g., the controller 210) may transmit additional object information to the robotic system 215.

In some implementations, the additional information may include information indicating a modification to the location, alignment, and/or orientation of the structural mold. In some implementations, the robotic system 215 may receive the additional information and may utilize the robotic arm 225 to modify the location, alignment, and/or orientation of the structural mold.

As shown in FIG. 2C, and by reference number 250, the 3D printing system 205 may utilize the AI component to determine printing information associated with printing the 3D object. For example, the 3D printing system 205 may provide the information associated with the 3D object and/or the object information to the AI component as inputs. The AI component may analyze the input information and may generate an output indicating one or more parameters associated with printing the 3D object.

In some implementations, the 3D object is printed by constructing a series of layers of granular particles. For example, initially, a first layer of granular particles may be deposited into the structural mold and a liquid binder material may be applied to the layer of granular particles to form a solidified layer corresponding to a portion of the 3D object.

In some implementations, the AI component may determine one or more parameters associated with printing each layer. For example, as shown in FIG. 2C, for each layer, the AI component may generate an output indicating a layer thickness (e.g., a thickness of the layer of granular particles), a type of granular particle(s) to be used, a type of liquid binder(s) to be used, whether a reinforcement material is to be added to the layer of granular particles, a first nozzle(s) 230 to be used to deposit the granular particles, a second nozzle(s) 230 to be used to apply the liquid binder material, and whether any additional nozzles are to be utilized (e.g., a third nozzle to deposit a reinforcement material).

In some implementations, the 3D printing system 205 (e.g., the AI component) may determine the layer thickness based on the received information associated with the 3D object, including design specifications and dimensions of the 3D object. In some implementations, the 3D printing system 205 may determine the layer thickness based on one or more properties of different granular particles. For example, the 3D printing system 205 may determine the layer thickness for each of the different granular particles based on a size, shape, and/or density of the granular particles.

In some implementations, the 3D printing system 205 may determine the layer thickness based on one or more properties of the liquid binder material. For example, the 3D printing system 205 may determine the layer thickness based on a viscosity and/or curing time of the liquid binder material. In some implementations, the 3D printing system 205 may utilize the AI component to calculate a thickness for each layer of granular particles based on one or more of the factors described above.

In some implementations, the 3D printing system 205 (e.g., the AI component) may select a type of granular particles, from multiple different types of granular particles, based on the information associated with the 3D object and/or the object information. In some implementations, the 3D printing system 205 may determine the type of granular particles based on material properties of the granular particles. For example, the 3D printing system 205 may determine the type of granular particles based on a strength, a texture, and/or a compatibility with different liquid binder materials. In some implementations, the 3D printing system 205 may determine the type of granular particles based on a size and a shape of the granular particles and the thickness of the layer which the granular particles are to form.

In some implementations, the 3D printing system 205 may determine that multiple different types of granular particles are to be utilized to print the layer of the 3D object. For example, the 3D printing system 205 may determine that multiples types of granular particles are to be used to print the layer of the 3D object based on a strength and/or a stability provided by the using a combination of the multiple types of granular particles.

In some implementations, the 3D printing system 205 may determine a volume or quantity of granular particles to be deposited into the structural mold to form the layer of granular particles. In some implementations, the 3D printing system 205 may determine the volume of granular particles based on a size and a shape of the granular particles and the thickness of the layer which the granular particles are to form.

In some implementations, the 3D printing system 205 (e.g., the AI component) may determine the liquid binder material based on one or more properties of the liquid binder material and/or a compatibility of the liquid binder material with the determined type of granular particles. For example, the 3D printing system 205 may determine the type of liquid binder material, from multiple different types of liquid binder material, based on a viscosity or flowability of the liquid binder material, a maximum or minimum flow rate associated with the liquid binder material, a curing time associated with the liquid binder material, a rate of absorption associated with the liquid binder material, adhesion properties associated with the liquid binder material, or a depth at which the liquid binder material penetrates into the granular particles, among other examples.

In some implementations, the 3D printing system 205 may determine a volume of liquid binder material to be applied to the layer of granular particles. In some implementations, the 3D printing system 205 may determine a volume of liquid binder material that is sufficient to cover, penetrate, and/or solidify a layer of the determined granular particles of the determined layer thickness. In some implementations, the 3D printing system 205 may determine the volume of liquid binder material based on the curing time, the rate of absorption, the adhesion properties, or the depth at which the liquid binder material penetrates into the granular particles.

In some implementations, the 3D printing system 205 (e.g., the AI component) may determine whether reinforcement material is needed based on the design specifications and structural requirements of the 3D object. In some implementations, the 3D printing system 205 may determine that a reinforcement material is to be included in the layer of granular particles. In these implementations, the 3D printing system 205 may determine a type of reinforcement material to be used and/or locations at which the reinforcement is to be deposited into the layer of granular particles. In some implementations, the 3D printing system 205 may determine whether the reinforcement material is deposited into the structural mold via a nozzle 230-3 (e.g., a nozzle from the third set of nozzles 230-3) and/or using the robotic arm 225. For example, the 3D printing system 205 may determine whether the reinforcement material is deposited into the structural mold via a nozzle 230 and/or using the robotic arm 225 based on a size of the reinforcement material, a shape of the reinforcement material, and/or a location within the layer of granular particles at which the reinforcement material is to be deposited, among other examples.

In some implementations, the 3D printing system 205 (e.g., the AI component) may determine a first nozzle(s) 230-1 from a plurality of first nozzles 230-1 associated with the 3D printer 220. In some implementations, the 3D printing system 205 may determine a first nozzle 230-1 based on one or more properties of the nozzle and/or one or more properties of the determined type of granular particles. For example, the 3D printing system 205 may determine the first nozzle 230-1 based on a size, or a range of sizes, of granular particle the first nozzle 230-1 is configured to deposit (e.g., a size of an opening of the first nozzle 230-1 via which the granular particles are deposited), a shape, or a range of shapes, of granular particle the first nozzle 230-1 is configured to deposit (e.g., a shape of the opening of the nozzle 230-1), a speed at which the first nozzle 230-1 is configured to deposit granular particles, or an accuracy associated with the first nozzle 230-1 depositing granular particles into a structural mold or onto a work surface, among other examples.

In some implementations, the 3D printing system 205 (e.g., the AI component) may determine the second nozzle(s) 230-2, from a plurality of second nozzles 230-2 associated with the 3D printer 220, based on one or more properties of the second nozzle(s) 230-2 and/or one or more properties of the liquid binder material. For example, the 3D printing system 205 may determine a second nozzle 230-2 for applying the liquid binder material to the layer of granular particles based on a spray pattern associated with the second nozzle 230-2, a maximum or minimum flow rate associated with the second nozzle 230-2, the flow rate at which the liquid binder material is applied to the layer of granular particles, whether the second nozzle 230-2 supports modifying the flow rate as the liquid binder material is being applied to the layer of granular particles, and/or the compatibility of the second nozzle 230-2 with the liquid binder material (e.g., whether the liquid binder material is likely to clog an opening of the second nozzle 230-2, whether the second nozzle 230-2 is likely to evenly and consistently apply the liquid binder material to the layer of granular particles, and/or the like).

In some implementations, the 3D printing system 205 (e.g., the AI component) may determine that additional nozzles 230 are to be utilized during the printing of the layer of the 3D object. For example, the 3D printing system 205 may determine that multiple first nozzles 230-1 are to be utilized to deposit the same or different types of granular particles, a second first nozzle 230-1 is to be utilized to deposit a reinforcement material, multiple second nozzles 230-2 are to be utilized to apply the same or different types of liquid binder material, or a third nozzle 230-3 is to be utilized to apply the same or different types of granular particles or reinforcement materials, among other examples. In these implementations, the 3D printing system 205 may determine one or more additional nozzles in a manner similar to that described above.

In some implementations, the output generated by the AI component may indicate one or more confidence scores associated with the one or more parameters. In some implementations, a confidence score may indicate a likelihood that a parameter or a set of parameters are accurately or correctly determined by the AI component.

In some implementations, the output may indicate a total confidence score associated with the one or more parameters. In some implementations, the total confidence score may indicate a likelihood that a combination of parameters indicated in the output are accurately or correctly determined.

In some implementations, the output may indicate a parameter confidence score associated with each parameter indicated in the output. For example, the output may indicate a confidence score associated with the layer thickness, a confidence score associated with the first nozzle, a confidence associated with the type of granular particles, a confidence score associated with the liquid binder material, a confidence score associated with the determination of whether a reinforcement material is to be used, and/or a confidence score associated with the determination of whether an additional nozzle 230 is to be used, among other examples.

In some implementations, the output may indicate a confidence score associated with non-determined or non-selected nozzles 230, granular particles, and/or liquid binder materials.

For example, the 3D printer 220 may be associated with a plurality of nozzles 230 (e.g., a plurality of first nozzles 230-1, a plurality of second nozzles 230-2, and/or a plurality of third nozzles 230-3) and the output may indicate a confidence score for each of the plurality of nozzles 230-1.

In some implementations, the 3D printing system 205 may receive the output from the AI component and may cause the 3D printer 220 to be configured based on the one or more parameters. For example, the 3D printing system 205 may provide the object information and the information indicating the one or more parameters to the 3D printer 220 to cause the 3D printer 220 to perform a configuration process. In some implementations, the configuration process may include causing the determined granular particles to be loaded into a reservoir (e.g., reservoir 260-1, shown in FIG. 2E) associated with the determined first nozzle 230-1 and causing the determined liquid binder material to be loaded into a reservoir (e.g., reservoir 260-2, shown in FIG. 2E) associated with the determined second nozzle 230-2, among other examples.

As shown in FIG. 2D, and by reference number 255, the 3D printer 220 may deposit the layer of granular particles into the structural mold based on receiving the one or more parameters and/or based on performing the configuration process. As shown in FIG. 2E, the first nozzle 230-1 includes a reservoir 260-1 that is configured to hold the granular particles and to enable the granular particles to travel from the reservoir 260-1 and into the structural mold 265 via the first nozzle 230-1.

In some implementations, the granular particles are loaded or stored in the reservoir 260-1, which is configured to hold a volume of granular particles for printing the layer of the 3D objects. In some implementations, the reservoir 260-1 is connected to the first nozzle 230-1, allowing the granular particles to be fed into the first nozzle 230-1. For example, the granular particles may be fed to the first nozzle 230-1 via a feeding mechanism that utilizes gravity or another force to cause a flow of granular particles from the reservoir 265-1 to the first nozzle 230-1.

In some implementations, the feeding of the granular particles into the first nozzle 230-1, may cause the first nozzle 230-1 to deposit the granular particles into the structural mold 265 to form a layer of granular particles 275. In some implementations, the first nozzle 230-1 may be controlled by the 3D printer 220 and/or the controller 210 to cause the deposition of the granular particles within the structural mold 265. For example, the 3D printer 220 may control the first nozzle 230-1 to cause the first nozzle 230-1 to move according to a predetermined path indicated in the object information.

In some implementations, the granular particles may be deposited into an empty structural mold 265. For example, the layer of granular particles may comprise a first or initial layer of the 3D object (or a portion of the 3D object). In some implementations, as shown in FIG. 2E, the granular particles may be deposited onto a solidified layer 270 of previously deposited granular particles. For example, the granular particles may be deposited onto the solidified layer 270 as a subsequent layer of granular particles forming a portion of the 3D object. In some implementations, the granular particles may adhere to the existing solidified layer (e.g., based on the application of a liquid binder material, as described below), to build up the 3D object layer by layer.

As the granular particles are deposited into the structural mold 265, the granular particles may form a new layer within the structural mold 265. In some implementations, the 3D printing system 205 may monitor one or more characteristics of the layer of granular particles as the layer of granular particles is deposited into the structural mold 265. For example, the 3D printing system 205 may utilize one or more sensors of the robotic system 215 to monitor the thickness and uniformity, among other examples, of the layer of granular particles.

In some implementations, the 3D printing system 205 may determine that a characteristic of the layer of granular particles fails to satisfy a condition and may cause one or more of the parameters to be modified based on the characteristic of the layer of granular particles failing to satisfy the condition. For example, the 3D printing system 205 may determine that first nozzle 230-1 is failing to deposit the granular particles in a uniform manner and may cause the 3D printer 220 to utilize a different first nozzle 230-1 (e.g., a first nozzle 230-1 having a larger or smaller opening) or a different type of granular particles (e.g., granular particles having a different size, shape or composition relative to the granular particles currently being deposited into the structural mold 265).

In some implementations, the 3D printing system 205 may determine to create and utilize an additional structural mold 265 based on the characteristics of the granular particles failing to satisfy the condition. For example, the 3D printing system 205 may cause the robotic system 215 to create an additional structural mold 265 in a manner similar to that described above.

In some implementations, the 3D printing system 205 may cause the additional structural mold 265 to be utilized for a remainder portion of the printing process. For example, the first nozzle 230-1 may dispense a portion of the granular particles and the 3D printing system 205 may receive information associated with the characteristics of the dispensed portion of granular particles.

In some implementations, the 3D printing system 205 may cause the 3D printer 220 to pause the printing process (e.g., to temporarily stop depositing granular particles into the structural mold 265 based on determining to utilize an additional structural mold 265). In some implementations, the 3D printing system 205 may cause the robotic system 215 to construct the additional structural mold 265 around the dispensed portion of granular particles based on the printing process being paused. In some implementations, the 3D printing system 205 may determine that the additional structural mold 265 has been constructed and the 3D printing system 205 may cause the 3D printer 220 to resume depositing a remainder portion of the granular particles based on the additional structural mold 265 being constructed around the portion of the granular particles.

In some implementations, the 3D printing system 205 may provide information indicating that the characteristic failed to satisfy the condition and/or information indicating the modifications to the one or more parameters to the AI component. In some implementations, the AI component may modify a confidence score associated with the one or more parameters, modify one or more weights or parameters of a machine learning model or a machine learning algorithm utilized by the AI component, or use the information to retrain the machine learning model.

As shown in FIG. 2F, and by reference number 280, the 3D printer 220 may use the second nozzle(s) 230-2 to apply the liquid binder material to the layer of granular particles based on depositing the granular particles into the structural mold. In some implementations, as shown in FIG. 2G, the liquid binder material is loaded or stored in the reservoir 260-2, which is configured to hold a volume of liquid binder material for printing the layer of the 3D objects. In some implementations, the reservoir 260-2 is connected to the second nozzle 230-2, allowing the liquid binder material to be fed into the second nozzle 230-2. For example, the liquid binder material may be fed to the second nozzle 230-2 via a feeding mechanism that utilizes a pump or another type of device to control a flow of liquid binder material from the reservoir 265-2 to the second nozzle 230-2.

In some implementations, the feeding of the liquid binder material into the second nozzle 230-2, may cause the second nozzle 230-2 to apply the liquid binder material to the layer of granular particles 275 to form a layer of granular particles and liquid binder material 285. In some implementations, the second nozzle 230-2 may be controlled by the 3D printer 220 and/or the controller 210 to cause the application of the liquid binder material at a configured flow rate. For example, the 3D printer 220 may control the feeding mechanism to cause the liquid binder material to flow from the reservoir 265-2 and onto the layer of granular particles via the second nozzle 230-2 at the configured flow rate.

In some implementations, the 3D printer 220 and/or the controller 210 may control a movement of the second nozzle 230-2 as the liquid binder material is applied to the layer of granular particles. For example, the 3D printer 220 and/or the controller 210 may cause the second nozzle 230-2 to move according to a predetermined path indicated in the object information.

In some implementations, as the liquid binder material is applied, the liquid binder material may penetrate the layer of granular particles 275, filling the spaces between the granular particles. The liquid binder material may gradually solidify, bonding the granular particles together to form a solidified layer. In some implementations, the printing process may continue in a similar manor layer by layer, with each new layer of granular particles being deposited and subsequently solidified by the liquid binder material.

In some implementations, the 3D printing system 205 may monitor one or more characteristics of the flow of the liquid binder material and/or the layer of granular particles and liquid binder material 285 as the liquid binder material is applied to the layer of granular particles. For example, the 3D printing system 205 may utilize one or more sensors of the robotic system 215 to monitor a flow rate, a rate of absorption, and/or a solidification of the granular particles, among other examples, as the liquid binder material is applied to the layer of granular particles.

In some implementations, the 3D printing system 205 may determine that a characteristic of the layer of granular particles and liquid binder material 285 fails to satisfy a condition and may cause one or more of the parameters to be modified based on the characteristic failing to satisfy the condition. For example, the 3D printing system 205 may determine that the rate of absorption and/or the solidification of the granular particles fail to satisfy a threshold. The 3D printing system 205 may adjust the flow rate of the liquid binder material based on the rate of absorption and/or the solidification of the granular particles failing to satisfy the threshold.

In some implementations, the 3D printing system 205 may provide information indicating that the characteristic failed to satisfy the condition and/or information indicating the modifications to the one or more parameters to the AI component. In some implementations, the AI component may modify a confidence score associated with the one or more parameters, modify one or more weights or parameters of a machine learning model or a machine learning algorithm utilized by the AI component, or use the information to retrain the machine learning model.

As shown in FIG. 2H, and by reference number 290, the 3D printing system 205 may receive layer information associated with the solidified layer of granular particles. In some implementations, the layer information may include information associated with the layer of granular particles deposited by the first nozzle 230-1 and the liquid binder material applied to the layer of granular particles by the second nozzle 230-2.

In some implementations, the layer information may include one or more parameters and/or data points obtained by one or more sensors of the robotic system 215. In some implementations, the layer information may include absorption information associated with the absorption of the liquid binder material by the granular particles. In some implementations, the absorption information may indicate a level of penetration and/or bonding of the liquid binder material with the granular particles.

In some implementations, the layer information may include stability information. In some implementations, the stability information may indicate a stability of the layer of granular particles and liquid binder material 285.

In some implementations, the layer information may include solidification information. In some implementations, the solidification information may indicate a solidification of the granular particles caused by the liquid binder material. In some implementations, the solidification information may indicate an extent to which the granular particles have solidified and bonded together after the application of the liquid binder material.

As shown in FIG. 2I, and by reference number 295, the 3D printing system 205 may perform one or more actions based on the layer information. In some implementations, the one or more actions may include retraining and/or modifying a machine learning model based on the layer information. In some implementations, the 3D printing system 205 may use the layer information as training data to retrain or modify an existing machine learning model of the AI component. In some implementations, retraining the machine learning model may include updating or modifying the machine learning model based on the data associated with layer of granular particles and liquid binder material 285 included in the layer information. In this way, the 3D printing system 205 may improve an accuracy and predictive capabilities of the machine learning model for determine parameters for subsequent layers of the 3D object. By continuously learning from the layer information, the machine learning model can optimize the printing process, ensuring better material deposition and structural integrity.

In some implementations, the one or more actions may include modifying the thickness of the layer of granular particles based on the layer information. For example, the 3D printing system 205 may adjust or modify the layer thickness based on structural characteristics of the layer of granular particles and liquid binder material 285. In this way, the 3D printing system 205 may ensure that the layer thickness is optimal for the specific properties of the granular particles and the liquid binder material, resulting in a more cohesive and structurally sound 3D object.

In some implementations, the one or more actions may include using a different type of granular particles. For example, the 3D printing system 205 may determine to use a different type of granular particles based on the layer information. In some implementations, the 3D printing system 205 may determine to utilize a different type of granular particles based on factors such as the desired strength, texture, and compatibility with the liquid binder material. In this way, the 3D printing system 205 may improve the quality and properties of the printed 3D object during the printing process (rather than having to re-print the 3D object due to the quality and properties of the printed 3D object failing to satisfy one or more conditions or criteria).

In some implementations, the one or more actions may include using a different type of liquid binder material. For example, the 3D printing system 205 may determine that a solidification of the granular particles fails to satisfy a threshold. The 3D printing system 205 may determine to utilize a different type of liquid binder material based on the solidification failing to satisfy the threshold.

In some implementations, the one or more actions may include using a different first nozzle 230-1 and/or a different second nozzle 230-2. For example, the 3D printing system 205 may determine to use a different first nozzle 230-1 based on using a different type of granular particle. As another example, the 3D printing system 205 may determine to utilize a different second nozzle 230-2 based on using a different type of liquid binder and/or modifying the flow rate.

In some implementations, the one or more actions may include adding a reinforcement material to the layer of granular particles and/or to subsequent layers of granular particles. For example, the 3D printing system 205 may determine that a structural characteristic of the layer of granular particles and liquid binder material 285 fails to satisfy a threshold. The 3D printing system 205 may determine to add a reinforcement material to the layer of granular particles and liquid binder material 285 and/or to subsequent layers of granular particles based on the structural characteristic failing to satisfy the threshold.

In some implementations, the one or more actions may include creating a structural mold. For example, the 3D printing system 205 may determine that a structural characteristic of the layer of granular particles and liquid binder material 285 fails to satisfy a threshold. The 3D printing system 205 may determine to utilize a structural mold (e.g., in place of, or in addition to, the structural mold 265) based on the structural characteristic failing to satisfy the threshold.

In some implementations, the one or more actions may include printing a next layer of the 3D object. For example, the 3D printing system 205 may determine that the layer of granular particles and liquid binder material is printed in accordance with the design specifications of the 3D object based on the layer information. The 3D printing system 205 may determine to print a next layer of the 3D object based on the layer of granular particles and liquid binder material being printed in accordance with the design specifications of the 3D object.

In some implementations, the one or more actions may include determining that the printing process is complete. For example, the 3D printing system 205 may determine that a last layer of the 3D object has been printed based on the layer information. The 3D printing system 205 may determine that the printing process is complete based on the last layer of the 3D object having been printed.

In some implementations, the one or more actions may include removing the structural mold 265. For example, the 3D printing system 205 may determine that the printing process is complete based on the layer information. The 3D printing system 205 may transmit an information to the robotic system 215 indicating that the printing process is complete. the robotic system 215 may receive the information and may utilize the robotic arm 225 to remove the structural mold 265 from the work surface of the 3D printer 220.

As indicated above, FIGS. 2A-2I are provided as an example. Other examples may differ from what is described with regard to FIGS. 2A-2I. The number and arrangement of devices shown in FIGS. 2A-2I are provided as an example. In practice, there may be additional devices, fewer devices, different devices, or differently arranged devices than those shown in FIGS. 2A-2I. Furthermore, two or more devices shown in FIGS. 2A-2I may be implemented within a single device, or a single device shown in FIGS. 2A-2I may be implemented as multiple, distributed devices. Additionally, or alternatively, a set of devices (e.g., one or more devices) shown in FIGS. 2A-2I may perform one or more functions described as being performed by another set of devices shown in FIGS. 2A-2I.

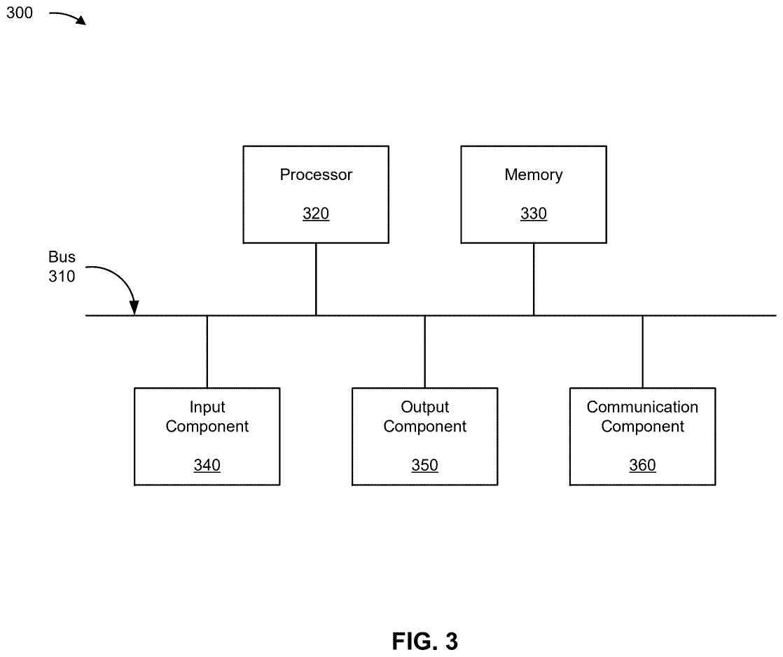

FIG. 3 is a diagram of example components of a device 300 associated with multi-nozzle 3D printing system. The device 300 corresponds to one or more of the 3D printing system 205, the robotic system 215, and/or the 3D printer 220. In some implementations, the 3D printing system 205, the controller 210, the robotic system 215, and/or the 3D printer 220 include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein. In some implementations, the processor 320 corresponds to the controller 210. In some implementations, the processor 320 may be included in the controller 210.

The memory 330 includes volatile and/or nonvolatile memory, such as RAM, ROM, a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

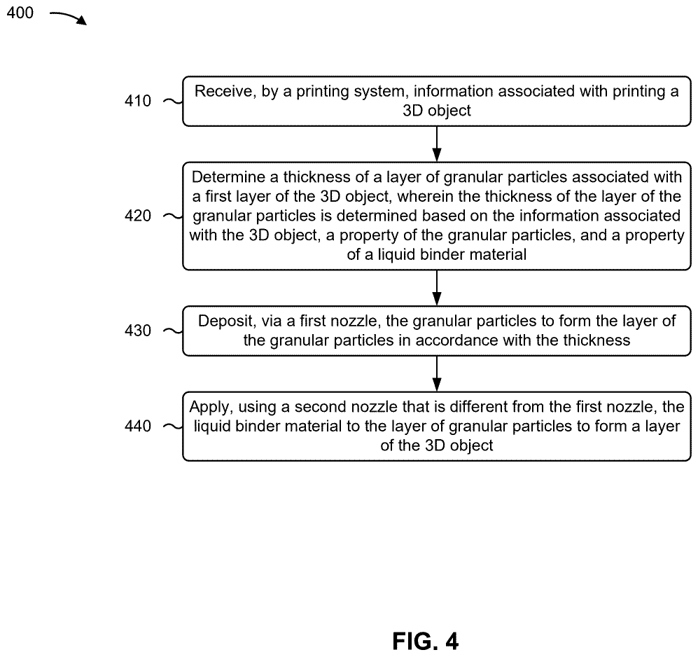

FIG. 4 is a flowchart of an example process 400 associated with multi-nozzle 3D printing system. One or more process blocks of FIG. 4 are performed by a printing system (e.g., a 3D printing system 205) and/or by another device or a group of devices separate from or including the printing system, such as a controller (e.g., a controller 210), a robotic system (e.g., a robotic system 215), and/or a 3D printer (e.g., a 3D printer 220). Additionally, or alternatively, one or more process blocks of FIG. 4 may be performed by one or more components of device 300, such as processor 320, memory 330, input component 340, output component 350, and/or communication component 360.

As shown in FIG. 4, process 400 includes receiving information associated with printing a 3D object (block 410). For example, the 3 d printing system may receive information associated with printing a 3D object, as described above.

As further shown in FIG. 4, process 400 includes determining a thickness of a layer of granular particles associated with a first layer of the 3D object, wherein the thickness of the layer of the granular particles is determined based on the information associated with the 3D object, a property of the granular particles, and a property of a liquid binder material (block 420). For example, the 3d printing system may determine a thickness of a layer of granular particles associated with a first layer of the 3D object, wherein the thickness of the layer of the granular particles is determined based on the information associated with the 3D object, a property of the granular particles, and a property of a liquid binder material, as described above.

As further shown in FIG. 4, process 400 includes depositing, via a first nozzle, the granular particles to form the layer of the granular particles in accordance with the thickness (block 430). For example, the 3d printing system may dispense, via a first nozzle, the granular particles to form the layer of the granular particles in accordance with the thickness, as described above.

As further shown in FIG. 4, process 400 includes applying, using a second nozzle that is different from the first nozzle, the liquid binder material to the layer of granular particles to form a layer of the 3D object (block 440). For example, the 3d printing system may apply, using a second nozzle that is different from the first nozzle, the liquid binder material to the layer of granular particles to form a layer of the 3D object, as described above.

Process 400 may include additional aspects, such as any single aspect or any combination of aspects described below and/or in connection with one or more other processes described elsewhere herein.

In a first aspect, applying the liquid binder material comprises controlling a flow rate and a volume of the liquid binder material based on the property of the granular particles and the property of the liquid binder material.

In a second aspect, alone or in combination with the first aspect, the granular particles comprise a type of granular particles and the liquid binder material comprises a type of liquid binder material, the method further comprising analyzing properties of a plurality of types of granular particles and properties of a plurality of types of liquid binder materials to identify features that influence layer thicknesses, wherein the plurality of types of granular particles includes the type of granular particles and the plurality of types of liquid binder materials includes the type of liquid binder materials, training a machine learning model to learn relationships between the identified features and the layer thicknesses, and providing the information associated with the 3D object as an input to the trained machine learning model to cause the trained machine learning model to generate an output indicating the thickness of the layer of the granular particles, the type of the granular particles, and the type of the liquid binder material.

In a third aspect, alone or in combination with one or more of the first and second aspects, the identified features include one or more of a particle size, a flowability, a viscosity, or a curing time.

In a fourth aspect, alone or in combination with one or more of the first through third aspects, the output further indicates a confidence score associated with the thickness of the layer of the granular particles, the type of the granular particles, and the type of the liquid binder material, the method further comprising receiving feedback information indicating a set of properties associated with the layer of the 3D object, and modifying the confidence score based on the feedback information.

In a fifth aspect, alone or in combination with one or more of the first through fourth aspects, process 400 includes receiving feedback information indicating a set of properties associated with the layer of the 3D object, and retraining the machine learning model based on the feedback information.

In a sixth aspect, alone or in combination with one or more of the first through fifth aspects, depositing the granular particles comprises determining to utilize a structural mold based on the information associated with the 3D object, the property of the granular particles, and the property of the liquid binder material, and depositing the granular particles into a structural mold, wherein the structural mold is configured to cause the granular particles to remain in a particular shape while the liquid binder material is applied to the layer of granular particles.

In a seventh aspect, alone or in combination with one or more of the first through sixth aspects, process 400 includes determining a shape and a dimension of a material for reinforcing the layer of the 3D object, and utilizing a third nozzle to position a reinforcement material at one or more locations based on the shape and the dimension of the material for reinforcing the layer of the 3D object, wherein the liquid binder material is applied to the layer of granular particles and the reinforcement material based on the reinforcement material being positioned at the one or more locations.

In an eighth aspect, alone or in combination with one or more of the first through seventh aspects, applying the liquid binder material comprises adjusting, during an application of the liquid binder material and based on the property of the granular particles and the property of the liquid binder material, one or more of a flow rate of the liquid binder material or a volume of the liquid binder material.

In a ninth aspect, alone or in combination with one or more of the first through eighth aspects, process 400 includes determining a set of properties associated with the granular particles, wherein the set of properties includes the property of the granular particles, and selecting the liquid binder material from a plurality of liquid binder materials based on the set of properties associated with the granular particles.

In a tenth aspect, alone or in combination with one or more of the first through ninth aspects, process 400 includes adding reinforcement materials to the layer of granular particles.

In an eleventh aspect, alone or in combination with one or more of the first through tenth aspects, the reinforcement materials comprise a set of objects having one or more of a size that is different from a size of the granular particles, a shape that is different from a shape of the granular particles, or a composition that is different from a composition of the granular particles.

In a twelfth aspect, alone or in combination with one or more of the first through eleventh aspects, applying the liquid binder material comprises adjusting a flow rate and a volume of the liquid binder material based on one or more of an amount of penetration of the liquid binder material into the layer of the granular particles, or a solidification of the layer of granular particles caused by the liquid binder material.

In a thirteenth aspect, alone or in combination with one or more of the first through twelfth aspects, the granular particles comprise a first type of granular particle and a second type of granular particle that is different from the first type of granular particle.

In a fourteenth aspect, alone or in combination with one or more of the first through thirteenth aspects, process 400 includes mixing the first type of granular particle and the second type of granular particle to obtain the granular particles to be deposited via the first nozzle.

In a fifteenth aspect, alone or in combination with one or more of the first through fourteenth aspects, process 400 includes selecting the first nozzle from a plurality of first nozzles based on one or more of the information associated with the 3D object, the property of the granular particles, or a property of the first nozzle.

In a sixteenth aspect, alone or in combination with one or more of the first through fifteenth aspects, process 400 includes selecting the second nozzle from a plurality of second nozzles based on one or more of the information associated with the 3D object, the property of the granular particles, the property of the liquid binder material, or a property of the second nozzle.

In a seventeenth aspect, alone or in combination with one or more of the first through sixteenth aspects, the property of the granular particles comprises one or more of a shape, a size, a material property, a flowability, a viscosity, or a curing time.

In an eighteenth aspect, alone or in combination with one or more of the first through seventeenth aspects, depositing the granular particles comprises depositing a portion of the granular particles, receiving information associated with the deposited portion of the granular particles, modifying the thickness of the layer of the granular particles based on the information associated with the deposited portion of the granular particles, and depositing another portion of the granular particles based on modifying the thickness of the layer of the granular particles.

In a nineteenth aspect, alone or in combination with one or more of the first through eighteenth aspects, depositing the granular particles comprises depositing a portion of the granular particles, receiving information associated with the deposited portion of the granular particles, constructing a structural mold around the deposited portion of the granular particles based on the information associated with the deposited portion of the granular particles, and depositing another portion of the granular particles into the structural mold.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations.

Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.” No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method comprising:
receiving, by a printing system, information associated with printing a three-dimensional (3D) object;
determining a thickness of a layer of granular particles associated with a first layer of the 3D object, wherein the thickness of the layer of the granular particles is determined based on the information associated with the 3D object, a property of the granular particles, and a property of a liquid binder material;
depositing, via a first nozzle, the granular particles to form the layer of the granular particles in accordance with the thickness; and
applying, using a second nozzle that is different from the first nozzle, the liquid binder material to the layer of granular particles to form a layer of the 3D object.

2. The method of claim 1, wherein applying the liquid binder material comprises:
controlling a flow rate and a volume of the liquid binder material based on the property of the granular particles and the property of the liquid binder material.

3. The method of claim 1, wherein the granular particles comprise a type of granular particles and the liquid binder material comprises a type of liquid binder material, the method further comprising:
analyzing properties of a plurality of types of granular particles and properties of a plurality of types of liquid binder materials to identify features that influence layer thicknesses, wherein the plurality of types of granular particles includes the type of granular particles and the plurality of types of liquid binder materials includes the type of liquid binder material;
training a machine learning model to learn relationships between the identified features and the layer thicknesses; and
providing the information associated with the 3D object as an input to the trained machine learning model to cause the trained machine learning model to generate an output indicating the thickness of the layer of the granular particles, the type of the granular particles, and the type of the liquid binder material.

4. The method of claim 3, wherein the identified features include one or more of a particle size, a flowability, a viscosity, or a curing time.

5. The method of claim 3, wherein the output further indicates a confidence score associated with the thickness of the layer of the granular particles, the type of the granular particles, and the type of the liquid binder material, the method further comprising:
receiving feedback information indicating a set of properties associated with the layer of the 3D object; and
modifying the confidence score based on the feedback information.

6. The method of claim 3, further comprising:
receiving feedback information indicating a set of properties associated with the layer of the 3D object; and
retraining the machine learning model based on the feedback information.

7. The method of claim 1, wherein depositing the granular particles comprises:
determining to utilize a structural mold based on the information associated with the 3D object, the property of the granular particles, and the property of the liquid binder material; and
depositing the granular particles into a structural mold, wherein the structural mold is configured to cause the granular particles to remain in a particular shape while the liquid binder material is applied to the layer of granular particles.

8. The method of claim 1, further comprising:
determining a shape and a dimension of a material for reinforcing the layer of the 3D object; and
utilizing a third nozzle to position a reinforcement material at one or more locations based on the shape and the dimension of the material for reinforcing the layer of the 3D object, wherein the liquid binder material is applied to the layer of granular particles and the reinforcement material based on the reinforcement material being positioned at the one or more locations.

9. The method of claim 1, wherein applying the liquid binder material comprises:
adjusting, during an application of the liquid binder material and based on the property of the granular particles and the property of the liquid binder material, one or more of a flow rate of the liquid binder material or a volume of the liquid binder material.

10. The method of claim 1, further comprising:
determining a set of properties associated with the granular particles, wherein the set of properties includes the property of the granular particles; and
selecting the liquid binder material from a plurality of liquid binder materials based on the set of properties associated with the granular particles.

11. The method of claim 1, further comprising:
adding reinforcement materials to the layer of granular particles.

12. The method of claim 11, wherein the reinforcement materials comprise a set of objects having one or more of:
a size that is different from a size of the granular particles,
a shape that is different from a shape of the granular particles, or
a composition that is different from a composition of the granular particles.

13. The method of claim 1, wherein applying the liquid binder material comprises:
adjusting a flow rate and a volume of the liquid binder material based on one or more of an amount of penetration of the liquid binder material into the layer of the granular particles, or a solidification of the layer of granular particles caused by the liquid binder material.

14. The method of claim 1, wherein the granular particles comprise a first type of granular particle and a second type of granular particle that is different from the first type of granular particle, and wherein the method further comprises:
mixing the first type of granular particle and the second type of granular particle to obtain the granular particles to be deposited via the first nozzle.

15. The method of claim 1, further comprising:
selecting the first nozzle from a plurality of first nozzles based on one or more of the information associated with the 3D object, the property of the granular particles, or a property of the first nozzle.

16. The method of claim 1, further comprising:
selecting the second nozzle from a plurality of second nozzles based on one or more of the information associated with the 3D object, the property of the granular particles, the property of the liquid binder material, or a property of the second nozzle.

17. The method of claim 1, wherein depositing the granular particles comprises:
depositing a portion of the granular particles;
receiving information associated with the deposited portion of the granular particles;
modifying the thickness of the layer of the granular particles based on the information associated with the deposited portion of the granular particles; and
depositing another portion of the granular particles based on modifying the thickness of the layer of the granular particles.

18. The method of claim 1, wherein depositing the granular particles comprises:
depositing a portion of the granular particles;
receiving information associated with the deposited portion of the granular particles;
constructing a structural mold around the deposited portion of the granular particles based on the information associated with the deposited portion of the granular particles; and
depositing another portion of the granular particles into the structural mold.

19. A printing system, comprising:
one or more memories; and
one or more processors, coupled to the one or more memories, configured to:
receive information associated with printing a three-dimensional (3D) object;
determine a thickness of a layer of granular particles associated with a first layer of the 3D object, wherein the thickness of the layer of the granular particles is determined based on the information associated with the 3D object, a property of the granular particles, and a property of a liquid binder material;
deposit, via a first nozzle, the granular particles to form the layer of the granular particles in accordance with the thickness; and
apply, using a second nozzle that is different from the first nozzle, the liquid binder material to the layer of granular particles to form a layer of the 3D object.

20. A non-transitory computer-readable medium storing a set of instructions, the set of instructions comprising:
one or more instructions that, when executed by one or more processors of a printing system, cause the printing system to:
receive information associated with printing a three-dimensional (3D) object;
determine a thickness of a layer of granular particles associated with a first layer of the 3D object, wherein the thickness of the layer of the granular particles is determined based on the information associated with the 3D object, a property of the granular particles, and a property of a liquid binder material;
deposit, via a first nozzle, the granular particles to form the layer of the granular particles in accordance with the thickness; and
apply, using a second nozzle that is different from the first nozzle, the liquid binder material to the layer of granular particles to form a layer of the 3D object.
